(19) United States
(12) Patent Application Publication
(10) Pub. No.: US 2025/0124487 A1
(43) Pub. Date: Apr. 17, 2025

(54) RECOMMENDATIONS BASED ON SEMANTIC UNDERSTANDING OF CONTENT ITEMS

(71) Applicant: Roblox Corporation, San Mateo, CA (US)

(72) Inventors: Xiaohong Gong, Sunnyvale, CA (US); Brian Su, Newark, CA (US); Lilong Jiang, Redwood City, CA (US)

(73) Assignee: Roblox Corporation, San Mateo, CA (US)

(21) Appl. No.: 18/916,597

(22) Filed: Oct. 15, 2024

Related U.S. Application Data
(60) Provisional application No. 63/590,665, filed on Oct. 16, 2023.

(51) Int. Cl. G06Q 30/0601

(52) U.S. Cl. CPC G06Q 30/0631

(57) ABSTRACT

According to one aspect of the present disclosure, a computer-implemented method is provided. The method includes obtaining a plurality of user-feature embeddings for a plurality of users. The method includes generating a respective user embedding for each of the plurality of users. The method includes organizing the plurality of users into a plurality of clusters based on user embeddings. The method includes identifying particular clusters based on a respective distance between the plurality of clusters and a particular user embedding of a user. The method may include calculating a respective term-frequency (TF)-inverse document frequency (IDF) (TF-IDF) metric for each content item interacted with by at least one user of that cluster. The method may include assigning a respective rank to the plurality of content items based on the respective TF-IDF metric. The method may include providing one or more of the plurality of candidate content items to a client device.

### CROSS-REFERENCE TO RELATED APPLICATIONS

This application is a non-provisional application that claims priority under 35 U.S.C. § 119 (e) to U.S. Provisional Patent Application No. 63/590,665, filed on Oct. 16, 2023, the contents of which are hereby incorporated by reference herein in its entirety.

### TECHNICAL FIELD

This disclosure relates generally to computer-based virtual environments, and more particularly but not exclusively, relates to methods, systems, and computer-readable media to recommend content items to users of virtual environments.

### BACKGROUND

Recommender systems are a tool to identify relevant items for a user. A recommender system can recommend products to customers, suggest similar products to those that a customer has already purchased, and/or recommend products that a customer might be interested in based on their activity. Some recommender systems utilize user-item interactions as input signals to identify items of interest to a user. Recommender systems can be used by businesses to increase sales and/or improve customer satisfaction. Recommender systems can also be used by individuals to make decisions, e.g., related to purchases.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method to provide content item recommendations to a particular user is provided. The method includes obtaining, by a processor, a plurality of user-feature embeddings based on respective user features for a plurality of users. The method includes generating, by the processor, a respective user embedding for each user of the plurality of users based on the plurality of user-feature embeddings using a first deep neural network (DNN). The method includes organizing, by the processor, the plurality of users into a plurality of clusters based on respective user embeddings. The method includes identifying, by the processor, using a nearest neighbor indexing technique, one or more particular clusters of the plurality of clusters based on a respective distance between the plurality of clusters and a particular user embedding of a particular user. The method may include identifying, by the processor, a plurality of candidate content items for recommendation to the particular user by, for each particular cluster of the one or more particular clusters, calculating, by the processor, a respective term-frequency (TF)-inverse document frequency (IDF) (TF-IDF) metric for each content item of a plurality of content items interacted with by at least one user associated with that cluster. The method may include identifying, by the processor, a plurality of candidate content items for recommendation to the particular user by, for each particular cluster of the one or more particular clusters, assigning, by the processor, a respective rank to the plurality of content items based on the respective TF-IDF metric. The method may include providing, by the processor, one or more of the plurality of candidate content items based on the respective ranks to a client device of the particular user for display in a user interface.

In some implementations, calculating the TF-IDF metric comprises, for each content item of the plurality of content items includes calculating a TF metric as ratio of a number of users in the particular cluster that interacted with the content item and a total number of users in the particular cluster. In some implementations, calculating the TF-IDF metric comprises, for each content item of the plurality of content items includes calculating an IDF metric as logarithm of a ratio of a total number of the plurality of clusters divided by a number of the plurality of clusters that include at least one user that interacted with the content item. In some implementations, calculating the TF-IDF metric comprises, for each content item of the plurality of content items includes calculating the TF-IDF metric for the content item by multiplying the TF metric with the IDF metric.

In some implementations, organizing the plurality of users into the plurality of clusters based on respective user embeddings includes calculating respective distances between pairs of user embeddings from the respective user embedding for each user of the plurality of users. In some implementations, organizing the plurality of users into the plurality of clusters based on respective user embeddings includes assigning individual users of the plurality of users to the plurality of clusters based on the respective distances.

In some implementations, organizing the plurality of users into the plurality of clusters is performed to minimize within-cluster variance and to maximize between-cluster variance.

In some implementations, identifying the plurality of candidate content items for recommendation to the particular user may include filtering the plurality of candidate content items based on one or more of a retention-rate threshold, a playtime duration threshold, an in-experience purchase amount threshold, game-play frequency, or removing candidate content items identified from clusters that have fewer than a threshold number of users.

In some implementations, the clustering is performed using a clustering technique selected from a group comprising K-means clustering, hierarchical clustering, density-based spatial clustering of applications with noise (DBSCAN), hierarchical DBSCAN (HDBSCAN), and a gaussian-mixture model (GMM) clustering.

In some implementations, the plurality of user-feature embeddings are obtained using the first DNN of a left tower of a two-tower model. In some implementations, the two-tower model further includes a right tower that includes a second DNN that generates item embeddings for content items based on respective item features. In some implementations, the first DNN and second DNN are trained jointly using a supervised loss such that pairs of user embeddings and item embeddings that have a groundtruth association have a lower vector distance between them in comparison to a vector distance between pairs of user embeddings and item embeddings that do not have the groundtruth association.

In some implementations, the particular user is a new user, and the method further includes generating a cold-start user embedding as the particular user embedding via a forward pass of the left tower.

According to another aspect of the present disclosure, a non-transitory computer-readable medium with instructions stored thereon that, when executed by one or more hardware processors, cause the one or more hardware processors to perform operations is provided. The operations include obtaining a plurality of user-feature embeddings based on respective user features for a plurality of users. The operations include generating a respective user embedding for each user of the plurality of users based on the plurality of user-feature embeddings using a first DNN. The operations include organizing the plurality of users into a plurality of clusters based on respective user embeddings. The operations include identifying using a nearest neighbor indexing technique, one or more particular clusters of the plurality of clusters based on a respective distance between the plurality of clusters and a particular user embedding of a particular user. The method may include identifying a plurality of candidate content items for recommendation to the particular user by, for each particular cluster of the one or more particular clusters, calculating a respective TF-IDF metric for each content item of a plurality of content items interacted with by at least one user associated with that cluster. The method may include identifying a plurality of candidate content items for recommendation to the particular user by, for each particular cluster of the one or more particular clusters, assigning a respective rank to the plurality of content items based on the respective TF-IDF metric. The method may include providing one or more of the plurality of candidate content items based on the respective ranks to a client device of the particular user for display in a user interface.

In some implementations, calculating the TF-IDF metric comprises, for each content item of the plurality of content items includes calculating a TF metric as ratio of a number of users in the particular cluster that interacted with the content item and a total number of users in the particular cluster. In some implementations, calculating the TF-IDF metric comprises, for each content item of the plurality of content items includes calculating an IDF metric as logarithm of a ratio of a total number of the plurality of clusters divided by a number of the plurality of clusters that include at least one user that interacted with the content item. In some implementations, calculating the TF-IDF metric comprises, for each content item of the plurality of content items includes calculating the TF-IDF metric for the content item by multiplying the TF metric with the IDF metric.

In some implementations, organizing the plurality of users into the plurality of clusters based on respective user embeddings includes calculating respective distances between pairs of user embeddings from the respective user embedding for each user of the plurality of users. In some implementations, organizing the plurality of users into the plurality of clusters based on respective user embeddings includes assigning individual users of the plurality of users to the plurality of clusters based on the respective distances.

In some implementations, organizing the plurality of users into the plurality of clusters is performed to minimize within-cluster variance and to maximize between-cluster variance.

In some implementations, identifying the plurality of candidate content items for recommendation to the particular user may include filtering the plurality of candidate content items based on one or more of a retention-rate threshold, a playtime duration threshold, an in-experience purchase amount threshold, game-play frequency, or removing candidate content items identified from clusters that have fewer than a threshold number of users.

In some implementations, the clustering is performed using a clustering technique selected from a group comprising K-means clustering, hierarchical clustering, DBSCAN, HDBSCAN, and a GMM clustering.

In some implementations, the plurality of user-feature embeddings are obtained using the first DNN of a left tower of a two-tower model. In some implementations, the two-tower model further includes a right tower that includes a second DNN that generates item embeddings for content items based on respective item features. In some implementations, the first DNN and second DNN are trained jointly using a supervised loss such that pairs of user embeddings and item embeddings that have a groundtruth association have a lower vector distance between them in comparison to a vector distance between pairs of user embeddings and item embeddings that do not have the groundtruth association.

In some implementations, the particular user is a new user, and the method further includes generating a cold-start user embedding as the particular user embedding via a forward pass of the left tower.

According to a further aspect of the present disclosure, a computing device is provided. The computing device may include one or more hardware processors and a non-transitory computer readable medium. The non-transitory computer-readable medium is coupled to the one or more hardware processors, with instructions stored thereon, that when executed by the one or more hardware processors to perform operations. The operations include obtaining a plurality of user-feature embeddings based on respective user features for a plurality of users. The operations include generating a respective user embedding for each user of the plurality of users based on the plurality of user-feature embeddings using a first DNN. The operations include organizing the plurality of users into a plurality of clusters based on respective user embeddings. The operations include identifying using a nearest neighbor indexing technique, one or more particular clusters of the plurality of clusters based on a respective distance between the plurality of clusters and a particular user embedding of a particular user. The method may include identifying a plurality of candidate content items for recommendation to the particular user by, for each particular cluster of the one or more particular clusters, calculating a respective TF-IDF metric for each content item of a plurality of content items interacted with by at least one user associated with that cluster. The method may include identifying a plurality of candidate content items for recommendation to the particular user by, for each particular cluster of the one or more particular clusters, assigning a respective rank to the plurality of content items based on the respective TF-IDF metric. The method may include providing one or more of the plurality of candidate content items based on the respective ranks to a client device of the particular user for display in a user interface.

In some implementations, calculating the TF-IDF metric comprises, for each content item of the plurality of content items includes calculating a TF metric as ratio of a number of users in the particular cluster that interacted with the content item and a total number of users in the particular cluster. In some implementations, calculating the TF-IDF metric comprises, for each content item of the plurality of content items includes calculating an IDF metric as logarithm of a ratio of a total number of the plurality of clusters divided by a number of the plurality of clusters that include at least one user that interacted with the content item. In some implementations, calculating the TF-IDF metric comprises, for each content item of the plurality of content items includes calculating the TF-IDF metric for the content item by multiplying the TF metric with the IDF metric.

In some implementations, organizing the plurality of users into the plurality of clusters based on respective user embeddings includes calculating respective distances between pairs of user embeddings from the respective user embedding for each user of the plurality of users. In some implementations, organizing the plurality of users into the plurality of clusters based on respective user embeddings includes assigning individual users of the plurality of users to the plurality of clusters based on the respective distances.

In some implementations, organizing the plurality of users into the plurality of clusters is performed to minimize within-cluster variance and to maximize between-cluster variance.

In some implementations, identifying the plurality of candidate content items for recommendation to the particular user may include filtering the plurality of candidate content items based on one or more of a retention-rate threshold, a playtime duration threshold, an in-experience purchase amount threshold, game-play frequency, or removing candidate content items identified from clusters that have fewer than a threshold number of users.

In some implementations, the clustering is performed using a clustering technique selected from a group comprising K-means clustering, hierarchical clustering, DBSCAN, HDBSCAN, and a GMM clustering.

In some implementations, the plurality of user-feature embeddings are obtained using the first DNN of a left tower of a two-tower model. In some implementations, the two-tower model further includes a right tower that includes a second DNN that generates item embeddings for content items based on respective item features. In some implementations, the first DNN and second DNN are trained jointly using a supervised loss such that pairs of user embeddings and item embeddings that have a groundtruth association have a lower vector distance between them in comparison to a vector distance between pairs of user embeddings and item embeddings that do not have the groundtruth association.

In some implementations, the particular user is a new user, and the method further includes generating a cold-start user embedding as the particular user embedding via a forward pass of the left tower.

### BRIEF DESCRIPTION OF THE DRAWINGS

FIG. 1 is a diagram of an example system architecture, in accordance with some implementations.

FIG. 2 illustrates a metric timeline for configuring a candidate generator, in accordance with some implementations.

FIG. 3 is a block diagram illustrating different components of a content item recommender, in accordance with some implementations.

FIG. 4 illustrates a diagram of a recommender system, in accordance with some implementations.

FIG. 5 illustrates an offline pipeline of a recommender system, in accordance with some implementations.

FIG. 6 is a diagram illustrating an example architecture of a user-content item two tower model, in accordance with some implementations.

FIG. 7 illustrates an example clustering technique, in accordance with some implementations.

FIG. 8 is a flowchart illustrating an example method to recommend content items, in accordance with some implementations.

FIG. 9 is a block diagram illustrating an example computing device, in accordance with some implementations.

### DETAILED DESCRIPTION

In a large-scale recommender system, ranking may be split into multiple stages. For example, ranking may include a candidate retrieval stage followed by a ranking stage. At the candidate retrieval stage, one or more candidate generators are utilized to retrieve as many high-quality content items (candidates) as possible from the eligible items (e.g., content items that are available for recommendation). Different candidate generators may be configured with different parameters to identify candidate items. At the ranking stage, the identified candidates are ranked based on the relevance of different candidates to the particular user to whom content item recommendations are to be provided.

To retrieve diverse and high-quality candidates, individual candidate generators need to generate candidates that are high quality and that do not overlap significantly with existing recommendations. In addition, in some cases, a requirement is that the generated candidates be personalized for different users. Systems, methods, and non-transitory computer-readable media are described herein to generate personalized high-quality and non-overlapping candidates.

In particular, a candidate generator that provides greater diversity of recommendations, including niche or less popular virtual experiences is described. Further, ranking techniques that provide diversity in recommended content items personalized to a user, e.g., virtual experiences listed in a home page of a virtual experience platform, are described.

Per techniques described herein, user features are obtained with user permission for a plurality of users of a virtual experience platform. Such user features may include static features such as demographic information (age, location, gender, etc.) as well as dynamic features (e.g., games/virtual experiences that the user participates in; content items purchased by the user; actions performed by the user on the virtual experience platform; the user's social connections, including friends on the virtual experience platform; etc.). User-feature embeddings are obtained that are representations of the user features in a high-dimensional vector space. A respective user embedding is obtained for each user, e.g., using a deep neural network (DNN).

Users of the virtual experience platform are organized into a plurality of clusters based on the respective user embeddings. User embeddings of users within a cluster are closer to each other in high-dimensional vector space than those for users in different clusters, such that users within a cluster have greater similarity with each other than with users in other clusters.

To provide content item recommendations to a particular user, a particular user embedding for the particular user is obtained and clusters that are near to the particular user embedding are identified, e.g., using a nearest neighbor indexing technique. For each cluster, a TF-IDF metric is computed for a plurality of content items based on interactions of users within the cluster with the content items. The TF-IDF metric is indicative of popularity of the content item (higher term frequency) as well as relative uniqueness of the content item to the cluster (low document frequency over the set of clusters indicates that the particular content item is more interacted with by a specific cluster or small number of clusters, whereas a high document frequency indicates content items that are more universally popular).

The identified content items are assigned a rank based on the TF-IDF metric. One or more content items from the identified content items are provided to the particular user, e.g., displayed in a user interface of a client device of the user. Content items can include any type of item on the virtual experience platform, such as for example, avatar accessories (e.g., clothing, headgear, footwear, etc.) that may be available for purchase; virtual experiences/games that a user can participate in; genres of virtual experiences; real-world items available for purchase on the virtual experience platform; etc.

### Example System Architecture

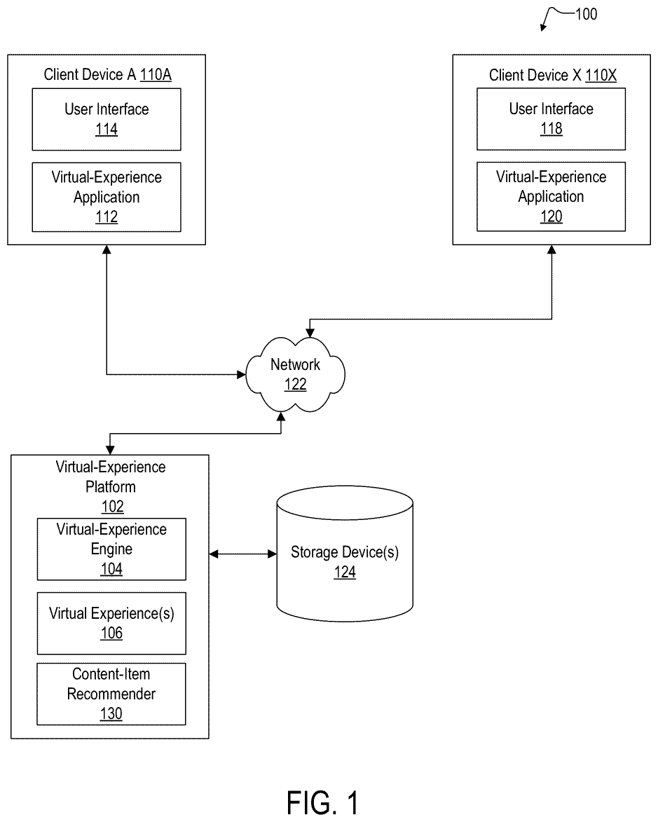

FIG. 1 is a diagram of an example system architecture 100 that includes a 3D virtual experience platform that can support construction and presentation of 3D objects, in accordance with some implementations. In the example of FIG. 1, the 3D virtual experience platform will be described in the context of a virtual-experience platform 102 purely for purposes of explanation, and various other implementations can provide other types of 3D virtual experience platforms, such as online meeting platforms, virtual reality (VR) or augmented reality (AR) platforms, or other types of platforms that can provide 3D content. The description provided herein for the virtual-experience platform 102 and other elements of the system architecture 100 can be adapted to be operable with such other types of 3D virtual experience platforms.

Virtual-experience platforms (also referred to as “user-generated content platforms” or “user-generated content systems”) offer a variety of ways for users to interact with one another, such as while the users are playing an electronic virtual experience. For example, users of a virtual-experience platform may work together towards a common goal, share various virtual gaming items, send electronic messages to one another, and so forth. Users of a virtual-experience platform may play virtual experiences using characters, such as the 3D avatars, which the users can navigate through a 3D world rendered in the electronic virtual experience.

A virtual-experience platform may also enable users of the platform to create and animate avatars, as well as enabling the users to create other graphical objects to place in the 3D world. For example, users of the virtual-experience platform may be allowed to create, design, and customize the avatar, and to create other 3D objects for presentation in the 3D world.

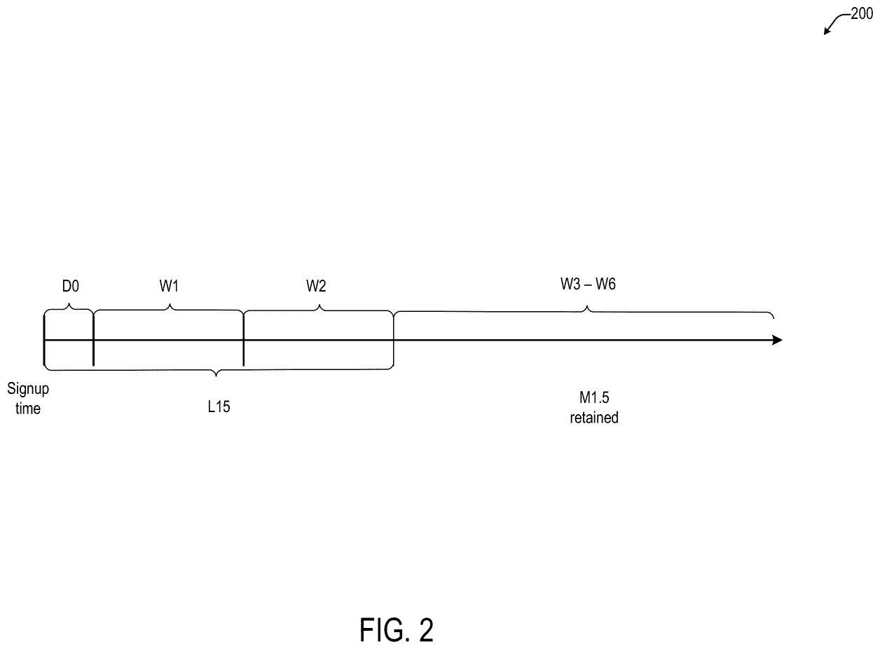

In FIG. 1, the example system architecture 100 (also referred to as “system” herein) includes the virtual-experience platform 102, a first client device 110a and at least one second client device X 110X (generally referred to as “client device(s) 110” herein). The virtual-experience platform 102 can include, among other things, a virtual-experience engine 104, one or more electronic virtual experiences 106, and a content-item recommender 130. The content-item recommender 130 may be configured to implement one or more of the operations described below with reference to FIGS. 2-8 to generate high-quality content-item recommendations. The system architecture 100 is provided for illustration of one possible implementation. In other implementations, the system architecture 100 may include the same, fewer, more, or different elements configured in the same or different manner as that shown in FIG. 1.

A communication network 122 may be used for communication between the virtual-experience platform 102 and the client devices 110, and/or between other elements in the system architecture 100. The network 122 may include a public network (e.g., the Internet), a private network (e.g., a local area network (LAN) or wide area network (WAN)), a wired network (e.g., Ethernet network), a wireless network (e.g., an 802.11 network, a Wi-Fi network, or wireless LAN (WLAN)), a cellular network (e.g., a long term evolution (LTE) network), routers, hubs, switches, server computers, or a combination thereof.

The client device 110A can include a virtual-experience application 112 and one or more user interface(s) 114 (e.g., audio/video input/output devices). Similarly, the client device X 110X can include a virtual-experience application 120 and one or more user interface(s) 118 (e.g., audio/video input/output devices). The audio/video input/output devices can include one or more of a microphone, speakers, headphones, display device, camera, etc.

The system architecture 100 may further include one or more storage device(s) 124. The storage device 124 may be, for example, a storage device located within the virtual-experience platform 102 or communicatively coupled to the virtual-experience platform 102 via the network 122 (such as depicted in FIG. 1). The storage device 124 may store, for example, graphical objects that are rendered in the virtual experience 106 by the virtual-experience engine 104 or by the virtual-experience applications 112/120, as well as the configuration/properties information of the graphical objects. In some implementations, storage device 124 may store, for example, user embeddings, a user embedding index, cluster identification (ID), and corresponding content items interacted with by users of a cluster.

In some embodiments, the storage devices 124 can be part of one or more separate content delivery networks that provide the graphical objects rendered in the virtual experience 106. For instance, an avatar creator can publish avatar templates in a library accessible at a first storage device, and other 3D object creators can (separately and independently from the avatar creator) publish 3D objects in a library accessible at a second storage device. Then, the virtual-experience application 112 may pull (or have pushed to it) graphical objects (avatars and other 3D objects) stored in the first/second storage devices, for computation/compilation at runtime for presentation during the course of playing the virtual experience.

In one implementation, the storage device 124 may be a non-transitory computer readable memory (e.g., random access memory), a cache, a drive (e.g., a hard drive), a flash drive, a database system, or another type of component or device capable of storing data and other content. The storage device 124 may also include multiple storage components (e.g., multiple drives or multiple databases) that may also span multiple computing devices (e.g., multiple server computers).

In some implementations, the virtual-experience platform 102 can include a server having one or more computing devices (e.g., a cloud computing system, a rackmount server, a server computer, cluster of physical servers, etc.). In some implementations, a server may be included in the virtual-experience platform 102, be an independent system, or be part of another system or platform.

In some implementations, the virtual-experience platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the virtual-experience platform 102 and to provide a user with access to virtual-experience platform 102. The virtual-experience platform 102 may also include a website (e.g., a web page) or application back-end software that may be used to provide a user with access to content provided by virtual-experience platform 102. For example, a user may access virtual-experience platform 102 using the virtual-experience application 112 on the client device 110.

In some implementations, virtual-experience platform 102 may be a type of social network providing connections between users or a type of user-generated content system that allows users (e.g., end-users or consumers) to communicate with other users on the virtual-experience platform 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, virtual-experience platform 102 may be a virtual gaming platform. For example, the gaming platform may provide single-player or multiplayer virtual experiences to a community of users that may access or interact with virtual experiences using client devices 110 via the network 122. In some implementations, virtual experiences (also referred to as “video virtual experience,” “online virtual experience,” or “virtual virtual experience,” etc. herein) may be two-dimensional (2D) virtual experiences, three-dimensional (3D) virtual experiences (e.g., 3D user-generated virtual experiences), virtual reality (VR) virtual experiences, or augmented reality (AR) virtual experiences, for example. In some implementations, users may participate in virtual experiences with other users. In some implementations, a virtual experience may be played in real-time with other users of the virtual experience.

In some implementations, virtual experiences may refer to interaction of one or more players using client devices (e.g., the client device 110) within a virtual experience (e.g., the virtual experience 106) or the presentation of the interaction on a display or other user interfaces (e.g., the user interface 114/118) of a client device 110.

In some implementations, the virtual experience 106 can include an electronic file that can be executed or loaded using software, firmware, or hardware configured to present the virtual experience content (e.g., digital media item) to an entity. In some implementations, the virtual-experience application 112 may be executed and the virtual experience 106 rendered in connection with the virtual-experience engine 104. In some implementations, the virtual experience 106 may have a common set of rules or common goal, and the environments of a virtual experience 106 share a common set of rules or common goal. In some implementations, different virtual experiences may have different rules or goals from one another.

In some implementations, virtual experiences may have one or more environments (also referred to as “gaming environments” or “virtual environments” herein) where multiple environments may be linked. An example of an environment may be a 3D environment. The one or more environments of the virtual experience 106 may be collectively referred to a “world” or “gaming world” or “virtual world” or “universe” herein. For example, a user may build a virtual environment that is linked to another virtual environment created by another user. A character of the virtual experience (such as a 3D avatar) may cross the virtual border to enter the adjacent virtual environment.

It may be noted that 3D environments or 3D worlds use graphics that provide a three-dimensional representation of geometric data representative of virtual experience content (or at least present virtual experience content to appear as 3D content whether or not 3D representation of geometric data is used). 2D environments or 2D worlds use graphics that provide two-dimensional representation of geometric data representative of virtual experience content.

In some implementations, the virtual-experience platform 102 can host one or more virtual experiences 106 and can permit users to interact with the virtual experiences 106 using the virtual-experience application 112 of the client device 110. Users of the virtual-experience platform 102 may play, create, interact with, or build virtual experiences 106, communicate with other users, and/or create and build objects (e.g., also referred to as “item(s)” or “virtual-experience objects” or “virtual experience item(s)” or “graphical objects” herein) of virtual experiences 106. For example, in generating user-generated virtual items, users may create characters, animation for the characters, decoration for the characters, one or more virtual environments for an interactive virtual experience, or build structures used in the virtual experience 106, among others. In some implementations, users may buy, sell, or trade virtual-experience objects, such as in-platform currency (e.g., virtual currency), with other users of the virtual-experience platform 102.

In some implementations, virtual-experience platform 102 may transmit virtual-experience content to virtual-experience applications (e.g., the virtual-experience application 112). In some implementations, virtual-experience content (also referred to as “content” or “content item” herein) may refer to any data or software instructions (e.g., virtual-experience objects, virtual experience, user information, video, images, commands, media item, etc.) associated with virtual-experience platform 102 or virtual-experience applications. In some implementations, virtual-experience objects (e.g., also referred to as “item(s)” or “objects” or “virtual experience item(s)” herein) may refer to objects that are used, created, shared, or otherwise depicted in the virtual experience 106 of the virtual-experience platform 102 or virtual-experience applications 112 or 120 of the client devices 110. For example, virtual-experience objects may include a part, model, character, or components thereof (like faces, arms, lips, etc.), tools, weapons, clothing, buildings, vehicles, currency, flora, fauna, components of the aforementioned (e.g., windows of a building), and so forth.

It may be noted that the virtual-experience platform 102 hosting virtual experiences 106 is provided for purposes of illustration. In some implementations, virtual-experience platform 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real-simple syndication (RSS) feeds, electronic comic books, software applications, etc. In some implementations, a media item may be an electronic file that can be executed or loaded using software, firmware or hardware configured to present the digital media item to an entity.

In some implementations, the virtual experience 106 may be associated with a particular user or a particular group of users (e.g., a private virtual experience), or made widely available to users of the virtual-experience platform 102 (e.g., a public virtual experience). In some implementations, where virtual-experience platform 102 associates one or more virtual experiences 106 with a specific user or group of users, virtual-experience platform 102 may associate the specific user(s) with a virtual experience 106 using user account information (e.g., a user-account identifier, such as username and password).

In some implementations, virtual-experience platform 102 or client devices 110 may include the virtual-experience engine 104 or virtual-experience application 112/120. In some implementations, virtual-experience engine 104 may be used for the development or execution of virtual experiences 106. For example, virtual-experience engine 104 may include a rendering engine (“renderer”) for 2D, 3D, VR, or AR graphics, a physics engine, a collision-detection engine (and collision response), sound engine, scripting functionality, animation engine, artificial-intelligence engine, networking functionality, streaming functionality, memory-management functionality, threading functionality, scene-graph functionality, or video support for cinematics, among other features. The components of the virtual-experience engine 104 may generate commands that help compute and render the virtual experience (e.g., rendering commands, collision commands, animation commands, physics commands, etc.). In some implementations, virtual-experience applications 112/118 of client devices 110 may work independently, in collaboration with virtual-experience engine 104 of virtual-experience platform 102, or a combination of both, to perform the operations described herein related to creating and presenting 3D objects.

In some implementations, both the virtual-experience platform 102 and client devices 110 execute a virtual-experience engine (104) or a virtual-experience application (112, 120). The virtual-experience platform 102 using virtual-experience engine 104 may perform some or all the virtual-experience engine functions (e.g., generate physics commands, animation commands, rendering commands, etc.), or offload some or all the virtual-experience engine functions to the virtual-experience application 112 of client device 110. In some implementations, each virtual experience 106 may have a different ratio between the virtual-experience engine functions that are performed on the virtual-experience platform 102 and the virtual-experience engine functions that are performed on the client devices 110.

For example, the virtual-experience engine 104 of the virtual-experience platform 102 may be used to generate physics commands in cases where there is a collision between at least two virtual-experience objects, while the additional virtual-experience engine functionality (e.g., generate rendering commands) may be offloaded to the client device 110. In some implementations, the ratio of virtual-experience engine functions performed on the virtual-experience platform 102 and client device 110 may be changed (e.g., dynamically) based on virtual-experience conditions. For example, if the number of users participating in a particular virtual experience 106 exceeds a threshold number, the virtual-experience platform 102 may perform one or more virtual-experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the virtual-experience platform 102. After receiving control instructions from the client devices 110, the virtual-experience platform 102 may send virtual-experience instructions (e.g., position and velocity information of the characters participating in the virtual experience or commands, such as rendering commands, collision commands, etc.) to the client devices 110 based on control instructions. For instance, the virtual-experience platform 102 may perform one or more logical operations (e.g., using virtual-experience engine 104) on the control instructions to generate virtual-experience instructions for the client devices 110. In other instances, virtual-experience platform 102 may pass one or more of the control instructions from one client device 110 to other client devices participating in the virtual experience 106. The client devices 110 may use the virtual-experience instructions and render the virtual experience for presentation on the displays of client devices 110.

In some implementations, the control instructions may refer to instructions that are indicative of in-virtual experience actions of a user's avatar. For example, control instructions may include user input to control the in-virtual experience action, such as right, left, up, down, user selection, gyroscope position and orientation data, force sensor data, etc. The control instructions may include character position and velocity information. In some implementations, the control instructions are sent directly to the virtual-experience platform 102. In other implementations, the control instructions may be sent from the client device 110 to another client device, where the other client device generates instructions using the local virtual-experience application 120. The control instructions may include instructions to play a voice communication message or other sounds from another user on an audio device (e.g., speakers, headphones, etc.), for example, voice communications or other sounds generated using the audio spatialization techniques as described herein.

In some implementations, virtual-experience instructions may refer to instructions that allow the client device 110 to render a virtual experience, such as a multiplayer virtual experience. The virtual-experience instructions may include one or more of user input (e.g., control instructions), character position and velocity information, or commands (e.g., physics commands, animation commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the virtual-experience platform 102 at any given moment. It may be noted that the number of client devices 110 is provided as illustration, rather than limitation. In some implementations, any number of client devices 110 may be used.

In some implementations, each client device 110 may include an instance of the virtual-experience application 112 or 120. In one implementation, the virtual-experience application 112 or 120 may permit users to use and interact with virtual-experience platform 102, such as control a virtual character in a virtual experience hosted by virtual-experience platform 102, or view or upload content, such as virtual experiences 106, images, video items, web pages, documents, and so forth. In one example, the virtual-experience application may be a web application (e.g., an application that operates in conjunction with a web browser) that can access, retrieve, present, or navigate content (e.g., virtual character in a virtual environment, etc.) served by a web server. In another example, the virtual-experience application may be a native application (e.g., a mobile application, app, or a gaming program) that is installed and executes local to client device 110 and allows users to interact with virtual-experience platform 102. The virtual-experience application 112/120 may render, display, or present the content (e.g., a web page, a media viewer) to a user. In an implementation, the virtual-experience application 112/120 may also include an embedded media player) that is embedded in a web page.

According to aspects of the disclosure, the virtual-experience application 112/120 may be a virtual-experience application for users to build, create, edit, upload content to the virtual-experience platform 102, as well as interact with virtual-experience platform 102 (e.g., play virtual experiences 106 hosted by virtual-experience platform 102). As such, the virtual-experience application 112/120 may be provided to the client device 110 by the virtual-experience platform 102. In another example, the virtual-experience application may be an application that is downloaded from a server.

In some implementations, a user may login to virtual-experience platform 102 via the virtual-experience application. The user may access a user account by providing user account information (e.g., username and password), where the user account is associated with one or more characters available to participate in one or more virtual experiences 106 of virtual-experience platform 102.

In general, functions described in one implementation as being performed by the virtual-experience platform 102 can also be performed by the client device(s) 110, or a server, in other implementations if appropriate. In addition, the functionality attributed to a particular component can be performed by different or multiple components operating together. The virtual-experience platform 102 can also be accessed as a service provided to other systems or devices through appropriate application programming interfaces (APIs), and thus is not limited to use in websites.

### Metric Timeline for Configuring a Candidate Generator

FIG. 2 illustrates a metric timeline 200 to configure a candidate generator, in accordance with some implementations. For the purposes of illustration, FIG. 2 uses user retention as an example metric to illustrate how a candidate generator works. The described techniques can however be easily applied to other metrics (e.g., content item purchase, spending on in-game purchases, etc.). The metric timeline 200 is illustrated with various definitions, as described below.

For instance, “D0” (day 0) refers to the first day that a user signs up for a virtual experience, “W1” (week 1) refers to days 1-7 after the user has signed up on D0, “W1 retention” refers to users that participated in the virtual experience on days 1-7 after signing up on D0. A virtual experience is “retained” by a user if that user participated in the virtual experience a threshold number (e.g., two or more) times for a threshold duration (e.g., greater than 15 minutes) over a time period (e.g., week 1 including days 1-7, day 0 excluded). “W2” refers to week 2 and “W3-W6” refers to weeks 3 through 6 after the initial signup. Thus, a user that continues to participate in the virtual experience is considered retained for 6 weeks (one and a half months), represented in FIG. 2 as “M1.5 retained.”

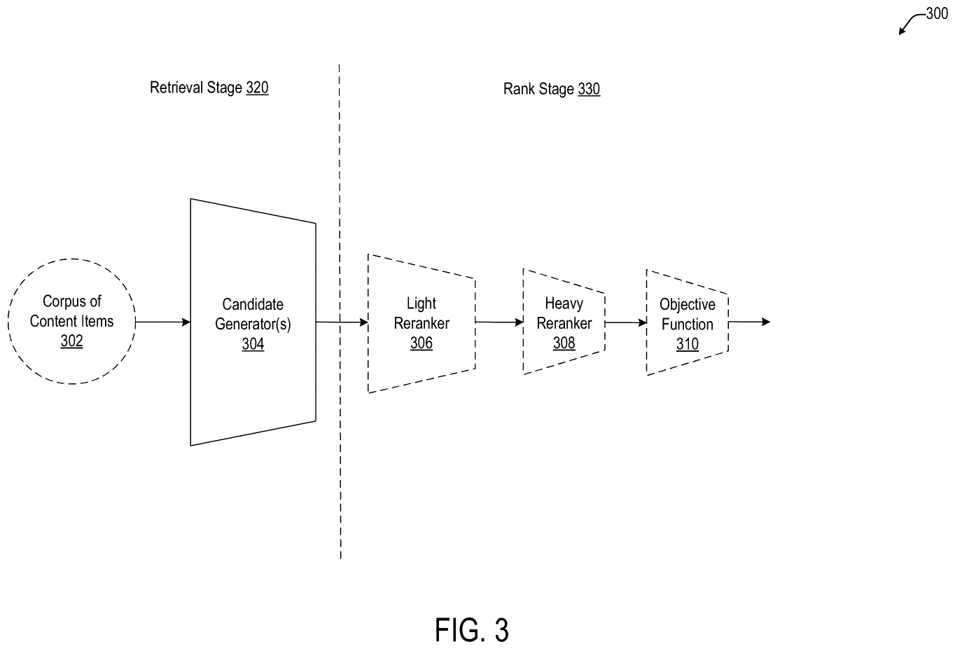

In various implementations, a candidate generator (described further with reference to FIG. 3 below) may be configured using only those virtual experiences that are “retained” by users, as described below.

### Content-Item Recommender

FIG. 3 is a block diagram illustrating different components of a content-item recommender 300, in accordance with some implementations.

Content items may include virtual experiences, content items for purchase, developer items, etc. Eligible content items 302 on the virtual-experience platform are identified. For example, certain virtual experiences may be deemed ineligible for a particular user, e.g., based on user age (e.g., a 15 year old user is ineligible for experiences that are for 17+ users); location (e.g., a user in India may be ineligible for experiences that are marked US-only); user device capabilities (e.g., processing, network, battery, etc.); etc. Further, certain virtual experiences may be deemed ineligible for other reasons, e.g., restrictions specified by the developer of the virtual experience, restrictions due to server capacity, network capacity, content items that are outside of a user-specified price, etc.

One or more candidate generators 304 identify candidate content items for recommendation. One or more of heavy reranker(s) 308 (e.g., that are computationally expensive) and a light reranker 306 may be utilized to assign ranks to the identified candidate content items. An objective function 310 may be optionally utilized to further filter the ranked content items and select one or more content items that are sent to a client device to display to the user. In different implementations, the content-item recommender 300 may be implemented as part of a virtual-experience application 112/120 and/or part of virtual-experience engine 104. While the description herein refers to recommendations of content items in the context of a virtual-experience platform (virtual environment) that includes virtual experiences, developer items, and content items for purchase, the techniques described herein are usable in any recommendation context, e.g., where the content items have semantic information (in one or modalities such as text, image, video, etc.), where the recommender needs to overcome a cold-start problem, etc.

In a multi-stage ranking system, as illustrated in FIG. 3, when a client request (e.g., request from an application for content-item recommendations) is received, one or more of the multiple candidate generators 304 are executed to retrieve the top K items from a corpus of items 302 (e.g., millions of items). Afterwards, one or more rerankers (306, 308) are executed to re-rank the top K items for a particular user. With user permission, the rerankers (306, 308) utilize a user profile (also referred to as user features) to output the top N content items (ranked from the K content items). A personalization backend (not shown) then provides the top N content items from the output of the rerankers (306, 308) to the client device (e.g., the requesting application). For example, if the requesting application is a virtual environment home page (e.g., where listings of available virtual experiences are provided), the ranked items may be virtual experiences to be shown the home page as recommendations from the virtual experience platform.

Still referring to FIG. 3, content-item recommendation may be split into multiple stages, such as a candidate retrieval stage 320 and a ranking stage 330.

The goal of the candidate retrieval stage 320 is to retrieve as many high-quality content items as possible from all eligible content items 302. Some implementations include a personalized user similarity-based candidate generator to retrieve virtual experiences with high frequency or high W1 retention. In some implementations, the virtual experiences that are recommended may be niche experiences (e.g., that are high quality but have metrics that appeal to a sub-group of users, rather than all users of the virtual experience platform).

The goal of the ranking stage 330 is to rank these candidates based on the relevance of these candidates to that particular user.

### Content-Item Recommender System

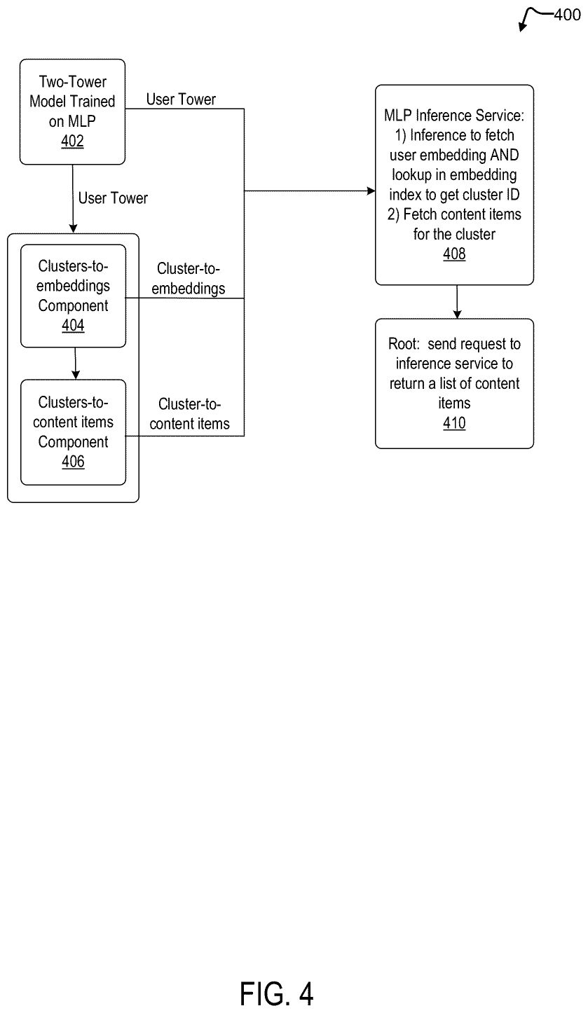

FIG. 4 illustrates a diagram of a recommender system 400, in accordance with some implementations. As shown in FIG. 4, recommender system 400 may include a two-tower model 402 trained on multi-layer perception (MLP), a clusters-to-embeddings component 404, a clusters-to-content items components 406, an MLP inference service 408, and a root 410. In FIG. 4, arrows are used to indicate the flow of data between the various components.

The two-tower model 402 may include a user tower and a content-item tower. In some implementations, the user tower may implement a first deep neural network (DNN) that is trained to generate user embeddings, and the content-item tower may implement a second deep neural network (DNN) that is trained to generate content-item embeddings.

The user tower may obtain a plurality of user-feature embeddings based on respective user features for a plurality of users and generate a respective user embedding for each of the plurality of users based on the plurality of user-feature embeddings using its corresponding DNN.

User-feature embeddings may be generated that are representations of the user features in a high-dimensional vector space. Such user features may include static features such as demographic information (age, location, gender, etc.) as well as dynamic features (e.g., games/virtual experiences that the user participates in; content items purchased by the user; actions performed by the user on the virtual experience platform; the user's social connections, including friends on the virtual experience platform; etc.). A respective user embedding may be obtained for each user, e.g., using a corresponding DNN.

Content-item embeddings may be generated based on content item features. For example, content items that are avatar accessories such as clothing, headgear, footwear, etc. may have an accessory type (e.g., cap, bandana, crown, etc. for headgear). Various content items may be associated with respective content item attributes (e.g., color, shape, size, etc.), type (e.g., avatar accessory, virtual object, real world object, etc.), and other aspects (e.g., user engagement and/or monetization features during a predetermined time period, embeddings from vision models or language models, etc.) or that may be provided as input to the second DNN to generate content item embeddings.

The clusters-to-embeddings component 404 may implement a clustering technique to organize the users into the plurality of clusters. In some implementations, the clustering technique may be selected from a group including, e.g., K-means clustering, hierarchical clustering, density-based spatial clustering of applications with noise (DBSCAN), hierarchical DBSCAN (HDBSCAN), and a gaussian-mixture model (GMM) clustering. Other clustering techniques may also be used.

In some implementations, clusters-to-embedding component 404 may organize the users into the plurality of clusters by calculating respective distances between pairs of user embeddings from the respective user embedding for each user of the plurality of users, and assigning individual users of the plurality of users to the plurality of clusters based on the respective distances. In some implementations, organizing the plurality of users into the plurality of clusters is performed to minimize within-cluster variance and to maximize between-cluster variance. Within-cluster variance refers to the variance of embedding values within a cluster (lower the variance, the more similar users within a cluster are), while between-cluster variance refers to the variance of embedding values in different clusters that are as far apart in vector space as possible (higher the variance, the more disparate users between the clusters are).

The clusters-to-content items component 406 may identify, for each cluster, a corresponding set of content items interacted with by users of that cluster. The corresponding set of content items may meet certain metrics. These metrics may include, e.g., content-item retention, content-item purchase, play, playtime, co-play, liked items, favorited items, among others.

When a content-item metric is used, clusters-to-content items component 406 may identify only those content items for which users in that cluster interacted with at least a predetermined number of times within a predetermined duration. In a non-limiting example, those content items that were interacted with (e.g., virtual experiences that a user participated in on days 1-7 after the user signed up on day 0) may be identified by clusters-to-content items component 406.

When a content-item purchase metric is used, clusters-to-content items component 406 may identify only those content items for which the users within that cluster made at least a predetermined number of in-game/in virtual-experience purchases or spent at least a predetermined amount. In a non-limiting example, those content items in which a user made two or more purchases may be identified by clusters-to-content items component 406.

MLP inference service 408 may receive the clusters organized by clusters-to-embeddings component 404, and a corresponding set of content items for each cluster identified by clusters-to-content items component 406.

When a new user signs up (or recommendations are to be provided to an existing user of a virtual experience platform), MLP inference service 408 may receive a request for content-item recommendations. MLP inference service 408 may generate a particular user embedding for the user using the user tower of the two-tower model 402. Using a nearest neighbor indexing technique, MLP inference service 408 may identify one or more particular clusters of the plurality of clusters based on a respective distance between the plurality of clusters and the particular user embedding.

Recommendations from several clusters may pooled together. This can be performed in several ways, e.g., by the cluster score, by ordering in terms of cluster similarity, by the associated rank, etc. Once the particular clusters are identified, MLP inference service 408 may fetch the corresponding content items for those clusters by sending a request to a root 410. In some implementations, the root 410 sends a request to one or more candidate generator MLP inference services (not shown). The request includes user features (e.g., determined based on a user profile) to enable personalization selection of the content-items that are returned for recommendation to the new user.

### Offline Content-Item Recommender Pipeline

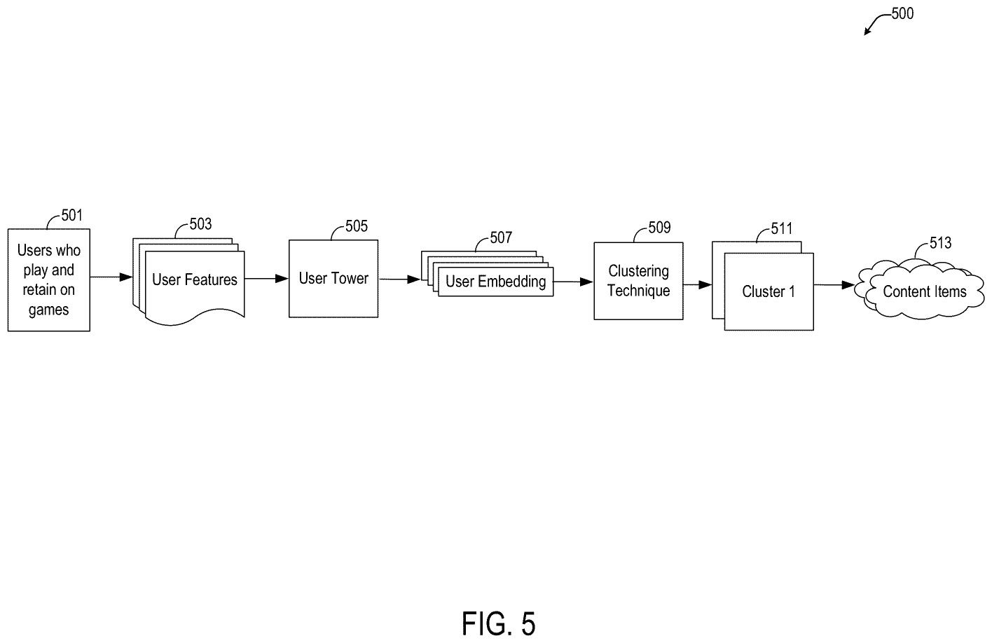

FIG. 5 illustrates an offline pipeline 500 of a candidate generator, in accordance with some implementations.

Referring to FIG. 5, the candidate generator may identify (at 501) a plurality of users who meet certain metric criteria, such as game retention or in-game purchase. For each of those users, the candidate generator may identify (at 503) a corresponding set of user features. The corresponding set of user features for a user may be input (at 505) to the user tower of the two-tower model to generate (at 507) a plurality of user embeddings.

The candidate generator may perform (at 509) a clustering technique to organize (at 511) the users into a plurality of clusters based on respective user embeddings. In some implementations, users are clustered into K clusters, e.g., using k-means (or other suitable clustering techniques). K-means clustering is an iterative algorithm that partitions a set of data points into k distinct, non-overlapping subsets (clusters) based on their distances to the mean values of the clusters. The technique minimizes the within-cluster variance while maximizing the between-cluster variance. The cluster centers (e.g., centroids) are indexed. index the cluster centers (centroids).

For each cluster, the virtual experiences played by the users in the cluster are pooled. The number of users within the cluster that have participated in the virtual experience are tracked. Low-quality experiences are removed using filters. For example, a filter may remove virtual experiences that fall below a particular W1 retention rate per cluster, e.g., below the 25th percentile, another filter may remove virtual experiences that have less than a threshold number of users within the cluster, still another filter may remove virtual experiences which do not meet a playtime duration threshold, yet another filter may remove virtual experiences that do not meet an in-experience purchase amount threshold, still a further filter may remove virtual experiences that do not meet a game-play frequency threshold, etc. Low-quality content items interacted with by users in each cluster may be filtered.

After the filtering, the final results (remaining virtual experiences) are ranked to identify (at 513) content items for display to a user. For example, the ranking may be based on a Term Frequency-Inverse Document Frequency (TF-IDF) score, e.g., using formulas (1), (2), and (3) below.

$$T F ( t , d ) = \frac{Number of users in cluster d who played item t}{Total number of users in cluster d} , \qquad ( 1 )$$

$$IDF ( t ) = log ( \frac{Total number of clusters ( documents )}{N umber of clusters ( documents ) containing item t} ) , \qquad ( 2 )$$

$$and$$

$$TFIDF ( t , d ) = T F ( t , d ) \times IDF ( t ) . \qquad ( 3 )$$

In this formulation, a content item (e.g., virtual experience) is treated as the term and the number of users that interact with the content item (e.g., that play that virtual experience) as the term frequency. The inverse document frequency (IDF) then weights these frequencies by considering the rarity of the item (e.g., content item) across all clusters (e.g., whether a virtual experience is played by users in a large number of clusters or is relatively rare and is limited to users from one cluster or a small number of clusters). The IDF thus emphasizes unique item preferences within each user cluster. While other techniques rank popular content items, e.g., that are interacted with by users in several clusters, the use of TF-IDF as described herein can improve retention while also increasing item diversity (e.g., homepage diversity for users including new users, where the homepage includes content item recommendations, such as recommended virtual experiences for the users to try out), and can surface niche experiences (since IDF is part of the TF metric).

At a time when recommendations are to be served, e.g., when the MLP inference service for the retention candidate generator is called, a cold-start user embedding (e.g., since a new user may not have sufficient user data to generate a user-specific embedding) as the particular user embedding is generated via a forward pass of the user tower and the closest clusters are returned from the index. Finding the nearest clusters can be done using a brute-force technique of comparing each embedding with all available cluster embeddings or using approximate nearest neighbor techniques. The retained virtual experiences for each cluster are aggregated and form the candidate list.

There are several advantages of the described techniques. The use of a two-tower model to generate user embeddings for retained users can capture relationships for other tasks, such as related virtual experiences and/or developer items. Leveraging TF-IDF can improve homepage diversity by surfacing niche content items. Further, the described techniques downrank popular virtual experiences that typically surface through other candidate generators. The described techniques can also be used to surface niche items to a cluster in other tasks.

In practice, the use of a retention candidate generator can improve new user play time and retention. Also, the techniques enable discovery of less popular or niche items by promoting diversity. The retention candidate generator promotes inclusion of new candidates in the recommendations provided to users.

While the foregoing description refers to the use of a retention candidate generator in recommending content items (e.g., on a homepage), the described techniques present a general-purpose candidate generator that can utilize existing pre-trained two-tower models.

### Training of Deep Neural Network (DNN): User-Content Item Two Tower Model

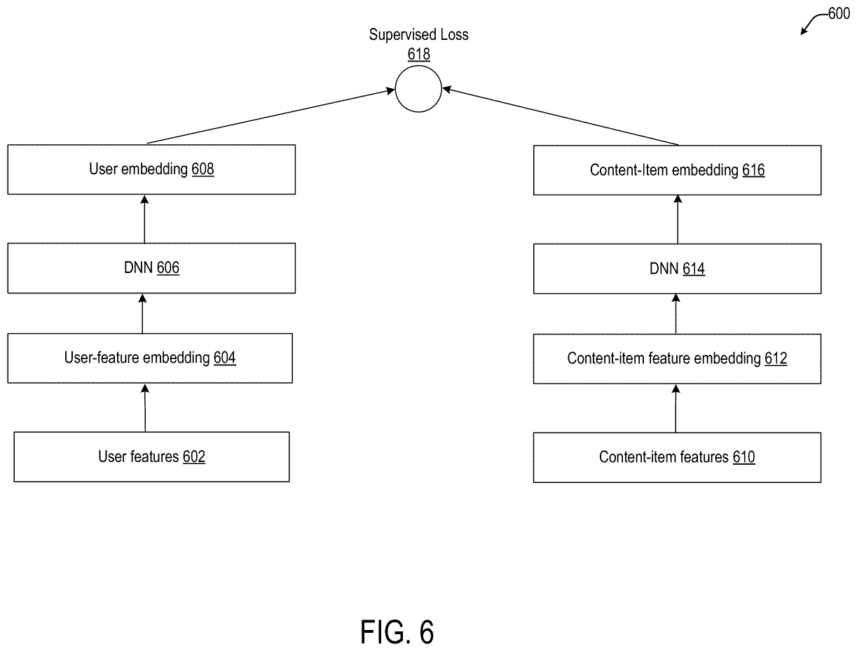

FIG. 6 is a diagram illustrating an example architecture of a user-content item two tower model 600, in accordance with some implementations. The two-tower model includes a left tower (blocks 602-608) that generates user embeddings 608 and a right tower (blocks 610-616) that generates content-item embeddings 616. Once trained, the left tower may be utilized to calculate a user embedding for a new user.

In some implementations, the user-content item two tower model may be utilized to train deep neural network (DNN) 606 and DNN 614 to generate respective user embeddings and content item embeddings. The training data may include a plurality of pairs of users and content items (e.g., user, content item) that have a groundtruth association. For example, if the content item is a developer item that the user purchased, there is a groundtruth association between the user and the developer item. In another example, if the content item is a virtual experience that the user participated in (played), there is a groundtruth association between the user and the virtual experience, where groundtruth association is based on the user history and indicates that the particular content item is of interest to the user. In various implementations, the plurality of pairs may be obtained automatically (based on prior user activity on the virtual-experience platform) and/or may be specific by the users (e.g., a user may provide a rating for a virtual experience or developer item, indicating their level of interest in that content item). The plurality of pairs in the training data may also include other pairs of users and content items, where there is no groundtruth association (e.g., unknown relationship) and/or negative association (user expresses disinterest in the content item).

During training, in the left tower, user-feature embeddings 604 may be calculated from user features 602 for each user in the plurality of pairs. The calculated user-feature embeddings 604 are provided to a first DNN 606 that generates a user embedding 608 based on the user-feature embeddings 604.

Further, during training, in the right tower, content-item feature embeddings 612 may be calculated from content-item features 610 for each content item in the plurality of pairs. The content-item features 610 may include one or more of item metadata (e.g., title, developer name, rating on the platform, item type, etc.) as well as text, audio, and visual information, such as image or video, associated with the item. The content-item feature embeddings 612 may be generated by encoding the content-item features 610 using a multimodal transformer and/or a cross-modal transformer that unifies the encoding across the various types of data in the item features. The calculated content-item feature embeddings 612 are provided to a second DNN 614 that generates a content-item embedding 616 based on the content-item feature embeddings 612.

Further, during training, a supervised loss 618 may be calculated as a vector distance between the user embedding 608 and the content-item embedding 616 for each pair. The loss function is selected such that for pairs where there is the groundtruth association, the loss is minimized. In other words, the vector distance between the user embedding 608 and the content-item embedding 616 is low for such pairs, whereas the vector distance in the absence of the groundtruth association is high. The loss value is utilized to adjust one or more parameters of first DNN 606 and/or second DNN 614. After the adjusting, the respective embeddings generated by first DNN 606 and second DNN 614 are closer in vector space for pairs with the groundtruth association. The training may be performed with a stopping criterion, e.g., compute budget exhausted, training data exhausted, threshold number of training epochs being completed, improvement between consecutive training iterations falling below a threshold, etc. Upon completion of the training, the left tower and the right tower can be utilized separately to generate user embeddings and item embeddings for incoming data in an inference phase. For instance, when a new user joins the virtual-experience platform, a cold-start user embedding is generated for the new user via a forward pass of the left tower.

The user-content item two tower model 600 is trained at regular intervals (e.g., daily) on D0 to generate user embeddings 608 for users having retained games in W1. The user embeddings 608 are representations of users in a high-dimensional space that model the inherent similarities and differences between users and content items.

### Clustering Technique

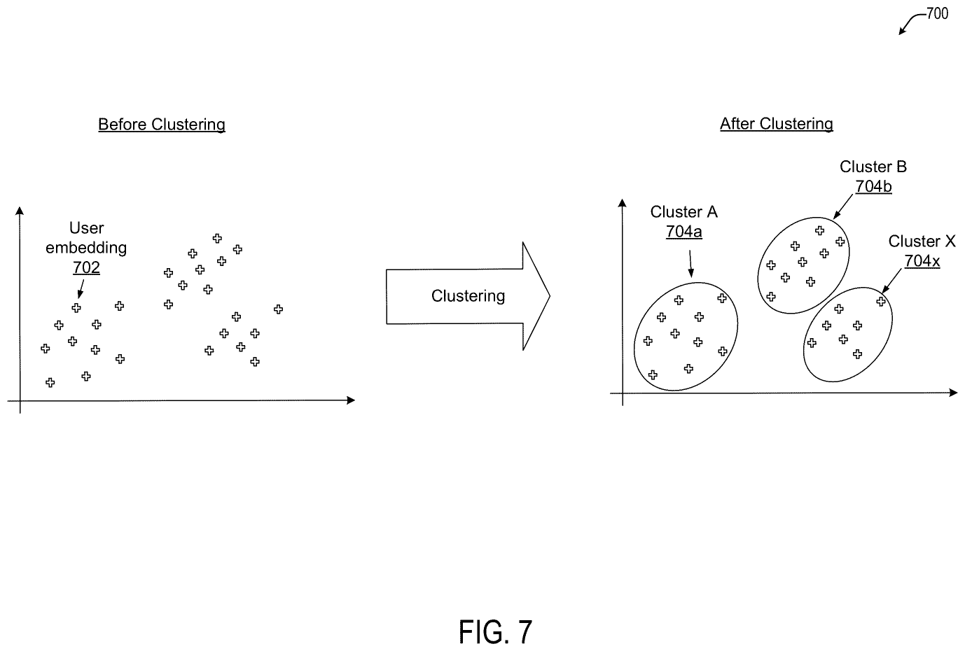

FIG. 7 illustrates an example clustering technique 700, in accordance with some implementations.

Referring to FIG. 7, a user embedding 702 for each of a plurality of users is shown before clustering. In the non-limiting example depicted in FIG. 7, the users are organized into one of Cluster A 704a, Cluster B 704b, or Cluster X 704x based on respective user embeddings 702. For instance, respective distances between pairs of user embeddings from the respective user embedding may be calculated for each user of the plurality of users. Individual users of the plurality of users may be assigned to one of Cluster A 702a, Cluster B 702b, or Cluster X 704x based on the respective distances.

In the non-limiting example illustrated in FIG. 7, a K-means clustering technique is shown. However, the clustering technique is not limited thereto, and other clustering techniques may be used. For instance, this other clustering technique may include, e.g., hierarchical clustering, density-based spatial clustering of applications with noise (DBSCAN), hierarchical DBSCAN (HDBSCAN), and a gaussian-mixture model (GMM) clustering. Other suitable clustering techniques may also be used.

### Identifying Candidate Content Items (Inference)

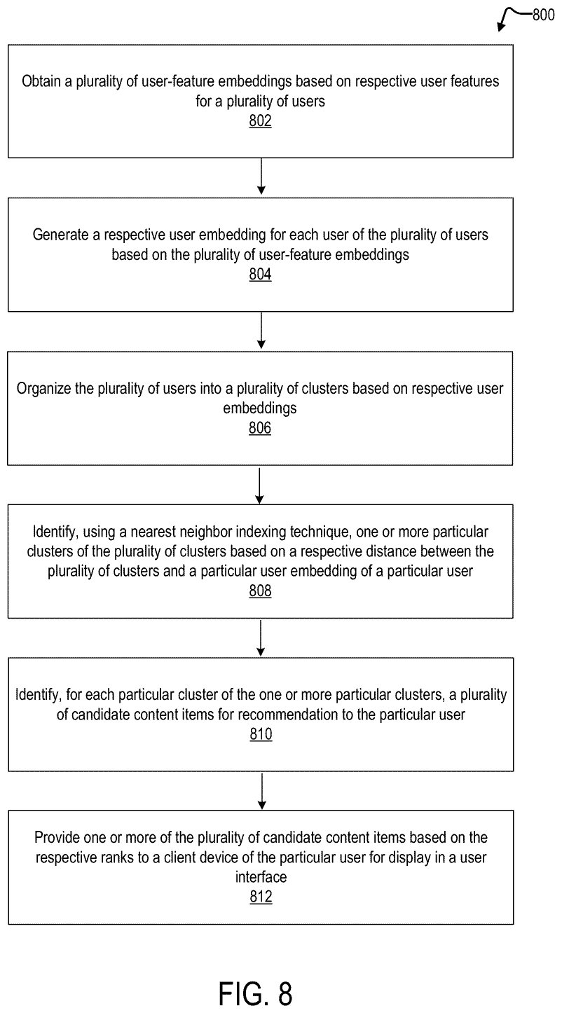

FIG. 8 is a flowchart illustrating an example method 800 to recommend content items, in accordance with some implementations. The method of FIG. 8 is implemented with specific user permission to access user data such as purchase history (e.g., of developer items such as avatar accessories, or other developer items), past play history (participation in one or more virtual experiences), context features such as the user-device type (e.g., desktop/laptop, smartphone, tablet, game console, or other computing device), user location (e.g., country), user language, or other features. In some implementations, the method of FIG. 8 may be used to implement one or more candidate generators 304 and/or the overall recommender system 400. In different implementations, method 800 may be implemented as part of a virtual-experience application 112/120 and/or part of virtual-experience engine 104.

Method 800 may begin at block 802. At block 802, a plurality of user-feature embeddings is obtained based on respective user features for a plurality of users.

In some implementations, user features for the user may be obtained, with user permission. For example, user features may include one or more of purchase history (e.g., of avatar accessories, developer items that can be purchased on the virtual-experience platform, etc.), past play history (participation in one or more virtual experiences), context features such as the user device type (e.g., desktop/laptop, smartphone, tablet, game console, or other computing device), user location (e.g., country), user language, or other features. A user-feature embedding for the user may be generated based on these features, including semantic information about the past played virtual experiences and/or the past purchased developer items.

For instance, in some implementations, the plurality of user-feature embeddings are obtained using a first DNN (e.g., DNN 606) of a left tower (602-608) of a two-tower model. In some implementations, the two-tower model further includes a right tower (610-616) that includes a second DNN (e.g., DNN 614) generates item embeddings for content items based on respective item features. In some implementations, the first DNN (e.g., DNN 606) and second DNN (e.g., DNN 614) are trained jointly using a supervised loss (618) such that pairs of user embeddings and item embeddings that have a groundtruth association have a lower vector distance between them in comparison to a vector distance between pairs of user embeddings and item embeddings that do not have the groundtruth association.

Block 804 may follow block 802. At block 804, a respective user embedding for each user of the plurality of users is generated based on the plurality of user-feature embeddings using a first DNN.

A user embedding is generated for the user based on the user feature embeddings using the first trained DNN (e.g., DNN 606). Content items that are associated with respective content item embeddings that are within a threshold distance of the user embedding are then selected. For example, in some implementations, content embeddings may be precomputed using a second trained DNN (e.g., DNN 614) and stored. Further, in some implementations, the user embedding may also be precomputed. As the content information is less ephemeral, e.g., since virtual experience, developer items, and/or content items for purchase may not change over time (or may change slowly), content item embeddings can be calculated offline, e.g., with a recurring pipeline that is executed at certain intervals (e.g., every 6 hours, 1 day, 1 week, upon changes to a threshold number or proportion of content items, etc.). Similarly, user embeddings may be precomputed and stored.

In some implementations, the user embedding may be a multidimensional vector that is calculated using any suitable technique. Since the user embeddings and/or item embeddings are obtained leveraging the content-specific information, these can be reused in other use cases (besides recommendation).

Block 806 may follow block 804. At block 806, the plurality of users are organized into a plurality of clusters based on respective user embeddings.

In some implementations, organizing the plurality of users into the plurality of clusters based on respective user embeddings includes calculating respective distances between pairs of user embeddings from the respective user embedding for each user of the plurality of users. In some implementations, organizing the plurality of users into the plurality of clusters based on respective user embeddings includes assigning individual users of the plurality of users to the plurality of clusters based on the respective distances.

In some implementations, organizing the plurality of users into the plurality of clusters is performed to minimize within-cluster variance and to maximize between-cluster variance.

In some implementations, the organizing is performed using a clustering technique selected from a group comprising K-means clustering, hierarchical clustering, density-based spatial clustering of applications with noise (DBSCAN), hierarchical DBSCAN (HDBSCAN), and a gaussian-mixture model (GMM) clustering.

Block 808 may follow block 806. At block 808, using a nearest neighbor indexing technique, one or more particular clusters of the plurality of clusters may be identified based on a respective distance between the plurality of clusters and a particular user embedding of a particular user.

In some implementations, the particular user is a new user, a cold-start user embedding for the particular user is generated as the particular using embedding via a forward pass of the left tower (602-608).

Block 810 may follow block 808. At block 810, for each particular cluster of the one or more particular clusters, a plurality of candidate content items are identified for recommendation to the particular user.

In some implementations, the plurality of candidate content items for recommendation may be identified by calculating a respective TF-IDF metric for each content item of a plurality of content items interacted with by at least one user associated with that cluster. In some implementations, the plurality of candidate content items for recommendation may be identified by assigning a respective rank to the plurality of content items based on the respective TF-IDF metric.

In some implementations, calculating the TF-IDF metric comprises, for each content item of the plurality of content items includes calculating a TF metric as ratio of a number of users in the particular cluster that interacted with the content item and a total number of users in the particular cluster. In some implementations, calculating the TF-IDF metric comprises, for each content item of the plurality of content items includes calculating an IDF metric as logarithm of a ratio of a total number of the plurality of clusters divided by a number of the plurality of clusters that include at least one user that interacted with the content item. In some implementations, calculating the TF-IDF metric comprises, for each content item of the plurality of content items includes calculating the TF-IDF metric for the content item by multiplying the TF metric with the IDF metric.

In some implementations, identifying the plurality of candidate content items for recommendation to the particular user may include filtering the plurality of candidate content items based on one or more of a retention-rate threshold or removing candidate content items identified from clusters that have fewer than a threshold number of users.

Block 812 may follow block 810. At block 812, one or more of the plurality of candidate content items based on the respective ranks are provided to a client device of the particular user for display in a user interface.

In some implementations, the plurality of candidate content items may be virtual experiences that include one or more developer items. In these implementations, the content item embedding for each virtual experience may be a learned embedding based on respective developer item embeddings of the one or more developer items.

In some implementations, the candidate content items may be virtual experiences that include a plurality of assets that include one or more of audio assets, visual assets, or text assets. In these implementations, the content item embedding for each virtual experience may be an asset embedding based on the plurality of assets associated with the virtual experience.

In some implementations, the candidate content items may be virtual experiences that include a plurality of assets and one or more developer items. In some of these implementations, the candidate content item embedding for each virtual experience may be a concatenation of an asset embedding based on the plurality of assets associated with the virtual experience and a learned embedding based on respective developer item embeddings of the one or more developer items.

In some implementations, the candidate content items are one or more content items for purchase. In some of these implementations, the content item embedding for each content item for purchase is a respective item feature embedding of the one or more content items.

### Computing Devices

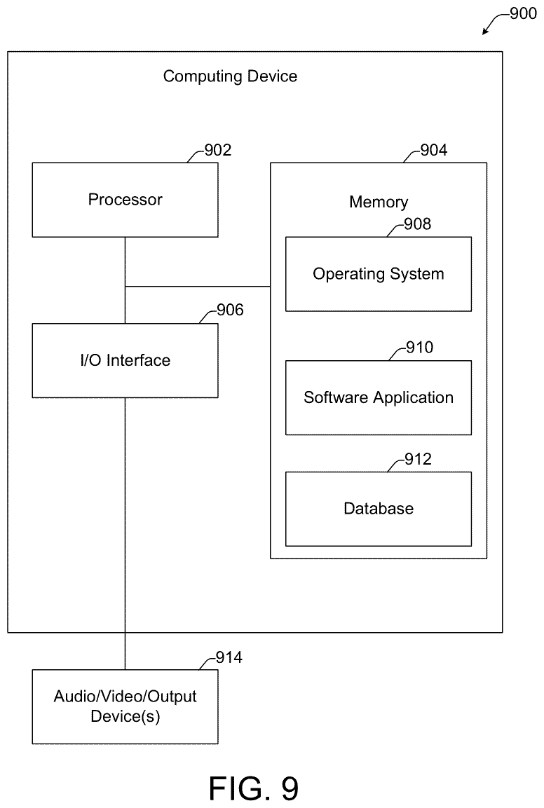

Hereinafter, a more detailed description of various computing devices that may be used to implement different devices and/or components illustrated in FIG. 1 is provided with reference to FIG. 9.

FIG. 9 is a block diagram of an example computing device 900 which may be used to implement one or more features described herein. The client devices 110 and/or the virtual-experience platform 102 of FIG. 1 may be provided in the form of the computing device 900 of FIG. 9. In one example, the computing device 900 may be used to perform the methods described herein. The computing device 900 can be any suitable computer system, server, or other electronic or hardware device. For example, the computing device 900 can be a mainframe computer, desktop computer, workstation, portable computer, or electronic device (portable device, mobile device, cell phone, smartphone, tablet computer, television, TV set top box, personal digital assistant (PDA), media player, virtual experience device, wearable device, etc.). In some implementations, the computing device 900 includes a processor 902, a memory 904, an input/output (I/O) interface 906, and audio/video input/output devices 914.

The processor 902 can be one or more processors and/or processing circuits to execute program code and control basic operations of the computing device 900. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

The memory 904 may be provided in the computing device 900 for access by the processor 902, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 902 and/or integrated therewith. The memory 904 can store software executable on the computing device 900 by the processor 902, including an operating system 908, one or more applications 910 (e.g., a virtual-experience application) and its related data 912. The application 910 is an example of a tool that can be used to embody the virtual-experience applications 112/120 or the virtual-experience engine 104. In some implementations, the application 910 can include instructions that, in response to execution by the processor 902, enable the processor 902 to perform or control performance of the operations described herein with respect to creating and/or presenting 3D objects.

Any software in the memory 904 can alternatively be stored on any other suitable storage location or computer-readable medium. In addition, memory 904 (and/or other connected storage device(s)) can store instructions and data used in the features described herein. Memory 904 and any other type of storage (magnetic disk, optical disk, magnetic tape, or other tangible media) can be considered “storage” or “storage devices.”

The I/O interface 906 can provide functions to enable interfacing the computing device 900 with other systems and devices. For example, network communication devices, storage devices, and input/output devices can communicate with the computing device 900 via an I/O interface 906. In some implementations, the I/O interface 906 can connect to interface devices including input devices (keyboard, pointing device, touchscreen, microphone, camera, scanner, etc.) and/or output devices (display device, speaker devices, printer, motor, etc.), which are collectively shown as at least one audio/video input/output device 914.

The audio/video input/output devices 914 can include an audio input device (e.g., a microphone, etc.) that can be used to receive audio messages as input, an audio output device (e.g., speakers, headphones, etc.) and/or a display device, that can be used to provide graphical and visual output such as rendered 3D avatars or other 3D objects.

For ease of illustration, FIG. 9 shows one block for each of processor 902, memory 904, I/O interface 906, the application 910, etc. These blocks may represent one or more processors or processing circuitries, operating systems, memories, I/O interfaces, applications, and/or software modules. In other implementations, the computing device 900 may not have all of the components shown and/or may have other elements including other types of elements instead of, or in addition to, those shown herein.

A user device can also implement and/or be used with features described herein. Example user devices can be computer devices including some similar components as the computing device 900, e.g., processor(s) 902, memory 904, and I/O interface 906. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 914, for example, can be connected to (or included in) the computing device 900 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., the method 800) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to provide content item recommendations to a particular user, the method comprising:
obtaining, by a processor, a plurality of user-feature embeddings based on respective user features for a plurality of users;
generating, by the processor, a respective user embedding for each user of the plurality of users based on the plurality of user-feature embeddings using a first deep neural network (DNN);
organizing, by the processor, the plurality of users into a plurality of clusters based on respective user embeddings;
identifying, by the processor, using a nearest neighbor indexing technique, one or more particular clusters of the plurality of clusters based on a respective distance between the plurality of clusters and a particular user embedding of the particular user;
identifying, by the processor, a plurality of candidate content items for recommendation to the particular user by, for each particular cluster of the one or more particular clusters,
calculating, by the processor, a respective term-frequency (TF)-inverse document frequency (IDF) (TF-IDF) metric for each content item of a plurality of content items interacted with by at least one user associated with that cluster; and
assigning, by the processor, a respective rank to the plurality of content items based on the respective TF-IDF metric; and
providing, by the processor, one or more of the plurality of candidate content items based on the respective ranks to a client device of the particular user for display in a user interface.

2. The computer-implemented method of claim 1, wherein calculating the TF-IDF metric comprises, for each content item of the plurality of content items comprises:
calculating a TF metric as ratio of a number of users in the particular cluster that interacted with the content item and a total number of users in the particular cluster;
calculating an IDF metric as logarithm of a ratio of a total number of the plurality of clusters divided by a number of the plurality of clusters that include at least one user that interacted with the content item; and
calculating the TF-IDF metric for the content item by multiplying the TF metric with the IDF metric.

3. The computer-implemented method of claim 1, wherein organizing the plurality of users into the plurality of clusters based on respective user embeddings comprises:
calculating respective distances between pairs of user embeddings from the respective user embedding for each user of the plurality of users; and
assigning individual users of the plurality of users to the plurality of clusters based on the respective distances.

4. The computer-implemented method of claim 1, wherein organizing the plurality of users into the plurality of clusters is performed to minimize within-cluster variance and to maximize between-cluster variance.

5. The computer-implemented method of claim 1, wherein identifying the plurality of candidate content items for recommendation to the particular user comprises:
filtering the plurality of candidate content items based on one or more of a retention-rate threshold, a playtime duration threshold, an in-experience purchase amount threshold, game-play frequency, or removing candidate content items identified from clusters that have fewer than a threshold number of users.

6. The computer-implemented method of claim 5, wherein the clustering is performed using a clustering technique selected from a group comprising K-means clustering, hierarchical clustering, density-based spatial clustering of applications with noise (DBSCAN), hierarchical DBSCAN (HDBSCAN), and a gaussian-mixture model (GMM) clustering.

7. The computer-implemented method of claim 1, wherein the plurality of user-feature embeddings are obtained using the first DNN of a left tower of a two-tower model, wherein the two-tower model further includes a right tower that includes a second DNN that generates item embeddings for content items based on respective item features, and wherein the first DNN and second DNN are trained jointly using a supervised loss such that pairs of user embeddings and item embeddings that have a groundtruth association have a lower vector distance between them in comparison to a vector distance between pairs of user embeddings and item embeddings that do not have the groundtruth association.

8. The computer-implemented method of claim 7, wherein the particular user is a new user, and further comprising generating a cold-start user embedding as the particular user embedding via a forward pass of the left tower.

9. A non-transitory computer-readable medium with instructions stored thereon that, when executed by one or more hardware processors, cause the one or more hardware processors to perform operations comprising:
obtaining a plurality of user-feature embeddings based on respective user features for a plurality of users;
generating a respective user embedding for each user of the plurality of users based on the plurality of user-feature embeddings using a first deep neural network (DNN);
organizing the plurality of users into a plurality of clusters based on respective user embeddings;
identifying using a nearest neighbor indexing technique, one or more particular clusters of the plurality of clusters based on a respective distance between the plurality of clusters and a particular user embedding of a particular user;
identifying a plurality of candidate content items for recommendation to the particular user by, for each particular cluster of the one or more particular clusters,
calculating a respective term-frequency (TF)-inverse document frequency (IDF) (TF-IDF) metric for each content item of a plurality of content items interacted with by at least one user associated with that cluster; and
assigning a respective rank to the plurality of content items based on the respective TF-IDF metric; and
providing one or more of the plurality of candidate content items based on the respective ranks to a client device of the particular user for display in a user interface.

10. The non-transitory computer-readable medium of claim 9, wherein calculating the TF-IDF metric comprises, for each content item of the plurality of content items comprises:
calculating a TF metric as ratio of a number of users in the particular cluster that interacted with the content item and a total number of users in the particular cluster;
calculating an IDF metric as logarithm of a ratio of a total number of the plurality of clusters divided by a number of the plurality of clusters that include at least one user that interacted with the content item; and
calculating the TF-IDF metric for the content item by multiplying the TF metric with the IDF metric.

11. The non-transitory computer-readable medium of claim 9, wherein organizing the plurality of users into the plurality of clusters based on respective user embeddings comprises:
calculating respective distances between pairs of user embeddings from the respective user embedding for each user of the plurality of users; and
assigning individual users of the plurality of users to the plurality of clusters based on the respective distances.

12. The non-transitory computer-readable medium of claim 9, wherein organizing the plurality of users into the plurality of clusters is performed to minimize within-cluster variance and to maximize between-cluster variance.

13. The non-transitory computer-readable medium of claim 9, wherein identifying the plurality of candidate content items for recommendation to the particular user comprises:
filtering the plurality of candidate content items based on one or more of a retention-rate threshold, a playtime duration threshold, an in-experience purchase amount threshold, game-play frequency, or removing candidate content items identified from clusters that have fewer than a threshold number of users.

14. The non-transitory computer-readable medium of claim 13, wherein the clustering is performed using a clustering technique selected from a group comprising K-means clustering, hierarchical clustering, density-based spatial clustering of applications with noise (DBSCAN), hierarchical DBSCAN (HDBSCAN), and a gaussian-mixture model (GMM) clustering.

15. The non-transitory computer-readable medium of claim 9, wherein the plurality of user-feature embeddings are obtained using the first DNN of a left tower of a two-tower model, wherein the two-tower model further includes a right tower that includes a second DNN that generates item embeddings for content items based on respective item features, wherein the first DNN and second DNN are trained jointly using a supervised loss such that pairs of user embeddings and item embeddings that have a groundtruth association have a lower vector distance between them in comparison to a vector distance between pairs of user embeddings and item embeddings that do not have the groundtruth association, and wherein the particular user is a new user, and the operations further comprise generating a cold-start user embedding as the particular user embedding via a forward pass of the left tower.

16. A computing device, comprising:
one or more hardware processors; and
a non-transitory computer readable medium coupled to the one or more hardware processors, with instructions stored thereon, that when executed by the one or more hardware processors to perform operations comprising:
obtaining a plurality of user-feature embeddings based on respective user features for a plurality of users;
generating a respective user embedding for each user of the plurality of users based on the plurality of user-feature embeddings using a first deep neural network (DNN);
organizing the plurality of users into a plurality of clusters based on respective user embeddings;
identifying using a nearest neighbor indexing technique, one or more particular clusters of the plurality of clusters based on a respective distance between the plurality of clusters and a particular user embedding of a particular user;
identifying a plurality of candidate content items for recommendation to the particular user by, for each particular cluster of the one or more particular clusters,
calculating a respective term-frequency (TF)-inverse document frequency (IDF) (TF-IDF) metric for each content item of a plurality of content items interacted with by at least one user associated with that cluster; and
assigning a respective rank to the plurality of content items based on the respective TF-IDF metric; and
providing one or more of the plurality of candidate content items based on the respective ranks to a client device of the particular user for display in a user interface.

17. The computing device of claim 16, wherein calculating the TF-IDF metric comprises, for each content item of the plurality of content items comprises:
calculating a TF metric as ratio of a number of users in the particular cluster that interacted with the content item and a total number of users in the particular cluster;
calculating an IDF metric as logarithm of a ratio of a total number of the plurality of clusters divided by a number of the plurality of clusters that include at least one user that interacted with the content item; and
calculating the TF-IDF metric for the content item by multiplying the TF metric with the IDF metric.

18. The computing device of claim 16, wherein organizing the plurality of users into the plurality of clusters based on respective user embeddings comprises:
calculating respective distances between pairs of user embeddings from the respective user embedding for each user of the plurality of users; and
assigning individual users of the plurality of users to the plurality of clusters based on the respective distances.

19. The computing device of claim 16, wherein organizing the plurality of users into the plurality of clusters is performed to minimize within-cluster variance and to maximize between-cluster variance.

20. The computing device of claim 16, wherein identifying the plurality of candidate content items for recommendation to the particular user comprises:
filtering the plurality of candidate content items based on one or more of a retention-rate threshold, a playtime duration threshold, an in-experience purchase amount threshold, game-play frequency, or removing candidate content items identified from clusters that have fewer than a threshold number of users.
